(19) United States
(12) Patent Application Publication
(10) Pub. No.: US 2014/0317577 A1
(43) Pub. Date: Oct. 23, 2014

(54) GESTURE CONTROLLABLE SYSTEM USES PROPRIOCEPTION TO CREATE ABSOLUTE FRAME OF REFERENCE

(71) Applicants: Njin-Zu Chen, Einhoven (NL); Paulus Thomas Arnoldus Thijssen, Goirle (NL)

(72) Inventors: Njin-Zu Chen, Einhoven (NL); Paulus Thomas Arnoldus Thijssen, Goirle (NL)

(73) Assignee: KONINKLIJKE PHILIPS N.V., EINDHOVEN (NL)

(21) Appl. No.: 13/977,743

(22) PCT Filed: Jan. 30, 2012
(86) PCT No.: PCT/IB2012/050422

§ 371 Date: Jul. 1, 2013

(30) Foreign Application Priority Data
Feb. 4, 2011 (EP) 11153274.3

(51) Int. Cl. G06F 3/01

(52) U.S. Cl. CPC G06F 3/017
USPC 715/863

(57) ABSTRACT

A system has a contactless user-interface for control of the system through pre-determined gestures of a bodily part of the user. The user-interface has a camera and a data processing system. The camera captures video data, representative of the bodily part and of an environment of the bodily part. The data processing system processes the video data. The data processing system determines a current spatial relationship between the bodily part and another bodily part of the user. Only if the spatial relationship matches a pre-determined spatial relationship representative of the pre-determined gesture, the data processing system sets the system into a pre-determined state.

### FIELD OF THE INVENTION

The invention relates to a system with a contactless user-interface configured for enabling a user to control the system in operational use through a pre-determined gesture of a bodily part of the user. The invention further relates to a contactless user-interface configured for use in such a system, to a method for controlling a system in response to a pre-determined gesture of a bodily part of the user, and to control-software operative to configure a system so as to be controllable in response to a pre-determined gesture of a bodily part of the user.

### BACKGROUND ART

Gesture-controllable systems, of the type specified in the preamble above, are known in the art see, for example, U.S. Pat. No. 7,835,498 issued to Bonfiglio et al, for “Automatic control of a medical device”; U.S. Pat. No. 7,028,269 issued to Cohen-Solal et al, for “Multi-modal video target acquisition and re-direction system and method”; US patent application publication 20100162177 filed for Eves et al., for “Interactive entertainment system and method of operation thereof” all assigned to Philips Electronics and incorporated herein by reference.

Within this text, the term “gesture” refers to a position or an orientation of a bodily part of the user, or to a change in the position or in the orientation (i.e., a movement) that is expressive of a control command interpretable by the gesture-controllable system.

A conventional gesture-controllable system typically has a contactless user-interface with a camera system for capturing video data representative of the user's gestures, and with a data processing system coupled to the camera system and operative to translate the video data into control signals for control of the gesture-controllable system.

A conventional gesture-controllable system typically provides relative control to the user, in the sense that the user controls a change in an operational mode or a state of the gesture-controllable system, relative to the current operational mode or current state. That is, the user controls the gesture-controllable system on the basis of the feedback from the gesture-controllable system in response to the movements of the user. For example, the relative control enables the user to control, through pre-determined movements, a change in a magnitude of a controllable parameter relative to a current magnitude, or to select from a list of selectable options in a menu a next option relative to a currently selected option. The user then uses the magnitude, or character, of the current change, brought about by the user's movements and as perceived by the user, as a basis for controlling the change itself via a feedback loop.

Alternatively, the conventional gesture-controllable system provides feedback to the user in response to the user's movements via, e.g., a display monitor in the graphical user-interface of the gesture-controllable system.

For example, the display monitor shows an indicium, e.g., a cursor, a highlight, etc., whose position or orientation is representative of the current operational mode or of the current state of the gesture-controllable system. The position or orientation of the indicium can be made to change, relative to a pre-determined frame of reference shown on the display monitor, in response to the movements of the user. By watching the indicium changing its position or orientation relative to the pre-determined frame of reference as displayed on the display monitor, the user can move under guidance of the visual feedback so as to home in on the desired operational mode or the desired state of the gesture-controllable system.

As another example of providing visual feedback, reference is made to “EyeToy Kinetic”, a physical exercise gaming title marketed by Sony in 2006. The EyeToy is a small digital camera that sits on top of a TV and plugs into the Playstation 2 (PS2), a video game console manufactured by Sony. The motion sensitive camera captures the user while standing in front of the TV, and puts the user's image on the display monitor's screen. The user then uses his arms, legs, head, etc., to play the game, for example, by means of controlling his/her image on the screen so as to have the image interact with virtual objects generated on the screen.

As yet another example of providing visual feedback, reference is made to “Fruit Ninja Kinect”, a video game for the Xbox 360 video console equipped with the Kinect, a motion camera, both manufactured by Microsoft. The movements of the user are picked up by the Kinect camera and are translated to movements of a human silhouette on the display monitor's screen. The game causes virtual objects, in this case, virtual fruits, being tossed up into the air, and the user has to control the human silhouette by his/her own movements so as to chop as many fruits as possible while dodging virtual obstacles.

As still another example of providing visual feedback, reference is made to “Kinect Adventures”, a video game marketed by Microsoft and designed for the Xbox 360 in combination with the Kinect motion camera mentioned earlier. The “Kinect Adventures” video game generates an avatar (e.g., a graphical representation of a humanoid), whose movements and motions are controlled by the full-body motion of the user as picked up by the camera.

### SUMMARY OF THE INVENTION

The inventors have recognized that a gesture-controllable system of one of above known types enables the user to control the system under guidance of feedback provided by the system in response to the user's gestures. The inventors have recognized that this kind of controllability has some drawbacks. For example, the inventors have observed that the user's relying on the feedback from the known system in response to the user's gestures, costs time and sets an upper limit to the speed at which the user is able to control the system by means of gestures. As another example, the user has to watch the movement of the indicium, or of another graphical representation, on the display monitor while trying to control the indicium's movements or the graphical representation's movements by means one or more gestures, and at the same time trying to check the effected change in operational mode or the change in state of the gesture-controllable system.

The inventors therefore propose to introduce a more intuitive and more ergonomic frame of reference so as to enable the user to directly set a specific one of multiple states of the system without having to consider feedback from the system during the controlling as needed in the known systems in order to home in on the desired specific state.

More specifically, the inventors propose a system with a contactless user-interface configured for enabling a user to control the system in operational use through a pre-determined gesture of a bodily part of the user. The user-interface comprises a camera system and a data processing system. The camera system is configured for capturing video data, representative of the bodily part and of an environment of the bodily part. The data processing system is coupled to the camera system. The data processing system is configured for processing the video data for: extracting from the video data a current spatial relationship between the bodily part, and a pre-determined reference in the environment; determining if the current spatial relationship matches a pre-determined spatial relationship between the bodily part and the pre-determined reference, the pre-determined spatial relationship being characteristic of the pre-determined gesture; and producing a control command for setting the system into a pre-determined state, in dependence on the current spatial relationship matching the pre-determined spatial relationship. The pre-determined reference comprises at least one of: another bodily part of the user; a physical object external to the user and within the environment; and a pre-determined spatial direction in the environment.

Control of the system in the invention is based on using proprioception and/or exteroception.

The term “proprioception” refers to a human's sense of the relative position and relative orientation of parts of the human body, and the effort being employed in the movements of parts of the body. Accordingly, proprioception refers to a physiological capacity of the human body to receive input for perception from the relative position, relative orientation and relative movement of the body parts. To illustrate this, consider a person, whose sense of proprioception happens to be impaired as a result of being intoxicated, inebriated or simply drunk as a sponge. Such a person will have difficulty in walking along a straight line or in touching his/her nose with his/her index finger while keeping his/her eyes closed. Traffic police officers use this fact to determine whether or not a driver is too intoxicated to operate a motor vehicle.

The term “exteroception” refers to a human's faculty to perceive stimuli from external to the human body. The term “exteroception” is used in this text to refer to the human's faculty to perceive the position or orientation of the human's body, or of parts thereof, relative to a physical object or physical influence external to the human's body and to perceive changes in the position or in the orientation of the human's body, or of parts thereof, relative to a physical object or physical influence external to the human's body. Exteroception is illustrated by, e.g., a soccer player who watches the ball coming into his/her direction along a ballistic trajectory and who swings his/her leg at exactly the right moment into exactly the right direction to launch the ball into the direction of the goal; or by a boxer who dodges a straight right from his opponent; or by a racing driver who adjusts the current speed and current path of his/her car in dependence on his/her visual perception of the speed, position and orientation of his/her car relative to the track and relative to the positions, orientations of the other racing cars around him/her, and in dependence on the tactile sense in the seat of his/her pants, etc., etc.

Accordingly, a (sober) human being senses the relative position and/or relative orientation and/or relative movement of parts of his/her body, and senses the position and/or orientation and/or movement of parts of his/her body relative to physical objects in his/her environment external to his/her body. As a result, the user's own body, or the user's own body in a spatial relationship with one or more physical objects external to the user and within the users' environment, serves in the invention as an absolute frame of reference that enables the user to directly select the intended state of the system through a gesture. This is in contrast with the user having to rely on feedback from the conventional gesture-controllable system in order to indirectly guide the conventional system to the intended state via correcting movements of his/her bodily part in a feedback loop involving the response of the conventional gesture-controllable system.

For example, the pre-determined reference comprises another bodily part of the user. The other bodily part serves as the frame of reference relative to which the first-mentioned bodily part is positioned or oriented or moved. The data processing system is configured to interpret the specific position and/or the specific orientation and/or the specific movement of, e.g., the user's hand or arm, relative to the rest of the user's body, as a specific gesture. The specific gesture is associated with a specific pre-determined control command to set the system into the specific one of the plurality of states. The user's sense of proprioception enables the user to intuitively put the bodily part and the other bodily part into the proper spatial relationship associated with the intended specific pre-determined control command. Optionally, the proper spatial relationship includes the bodily part of the user physically contacting the other bodily part of the user. The physical contact of the bodily parts provides additional haptic feedback to the user, thus further facilitating selecting the intended state to be assumed by the system.

Alternatively, or in addition, the pre-determined reference comprises a physical object, as captured by the camera system, and being present within the environment external to the user. The physical object may be a piece of hardware physically connected to, or otherwise physically integrated with, the system itself, e.g., a housing of the system such as the body of a light fixture (e.g., the body of a table lamp). As another example, the physical object comprises another article or commodity that is not physically connected to, and not otherwise physically integrated with, the system, e.g., a physical artifact such as a chair, a vase, or a book; or the user's favorite pet.

The physical artifact or the pet is chosen by the user in advance to serve as the reference. In this case, the data processing system of the user-interface needs to be programmed or otherwise configured in advance, in order to interpret the physical artifact or the pet, when captured in the video data, as the reference relative to which the user positions or orients the bodily part.

Alternatively, or in addition, the pre-determined reference comprises a pre-determined spatial direction in the environment, e.g., the vertical direction or the horizontal direction as determined by gravity, or another direction selected in advance. As mentioned above, the sense of proprioception also involves the effort being employed by the user in positioning or orienting or moving one or more parts of his/her body. For example, the gravitational field at the surface of the earth introduces anisotropy in the effort of positioning or orienting: it is easier for the user to lower his/her arm over some distance than to lift his/her arm over the same distance, owing to the work involved.

The term “work” in the previous sentence is a term used in the field of physics and refers to for the amount of energy produced by a force when moving a mass) involved. Positioning or orienting a bodily part in the presence of a gravitational field gives rise to exteroceptive stimuli. For example, the data processing system in the gesture-controllable system of the invention is configured to determine the pre-determined spatial direction in the environment relative to the posture of the user captured by the camera system. The pre-determined spatial direction may be taken as the direction that is parallel to a line of symmetry in a picture of the user facing the camera, the line running, e.g., from the user's head to the user's torso or the user's feet, or the line running from nasal bridge via the tip of the user's nose to the user's chin. The line of symmetry may be determined by the data processing system through analysis of the video data. As another example, the camera system is provided with an accelerometer to determine the direction of gravity in the video captured by the camera system. The camera system may send the video data to the data processing system together with metadata representative of the direction of gravity.

Within this context, consider gesture-based controllable systems, wherein a gesture involves a movement of a bodily part of the user, i.e., a change over time in position or in orientation of the bodily part relative to the camera. A thus configured system does not need a static reference position or a static reference orientation, as the direction of change relative to the camera, or a spatial sector relative to the camera wherein the change occurs, is relevant to interpreting the gesture as a control command. In contrast, in the invention, the relative position and/or the relative orientation and/or relative movement of a bodily part of the user, as captured in the video data, with respect to the pre-determined reference, as captured in the video data, is interpreted as a control command. For completeness, it is remarked here that the invention can use video data representative of the bodily part and of the environment in two dimensions or in three dimensions.

The system of the invention comprises, for example, a domestic appliance such as kitchen lighting, dining room lights, a television set, a digital video recorder, a music player, a home-entertainment system, etc. As another example, the system of the invention comprises hospital equipment. Hospital equipment that is gesture-controllable enables the medical staff to operate the equipment without having to physically touch the equipment, thus reducing the risk of germs or micro-organs being transferred to patients via the hospital equipment. As yet another example, the system of the invention comprises workshop equipment within an environment wherein workshop personnel get their hands or clothing dirty, e.g., a farm, a zoo, a foundry, an oil platform, a workshop for repairing and servicing motor vehicles, trains or ships, etc. If the personnel do not have to physically touch the workshop equipment in order to control it, dirt will not accumulate at the user-interface as fast as if they had to touch it. Alternatively, the personnel will not need to take off their gloves to operate the equipment, thus contributing to the user-friendliness of the equipment.

The user's gestures in the interaction with the gesture-controllable system of the invention may be, e.g., deictic, semaphoric or symbolic. For background, please see, e.g., Karam, M., and Schraefel, M. C., (2005), “A Taxonomy of Gestures in Human Computer Interaction”, ACM Transactions on Computer-Human Interactions 2005, Technical report, Electronics and Computer Science, University of Southampton, November 2005.

A deictic gesture involves the user's pointing in order to establish an identity of spatial location of an object within the context of the application domain. For example, the user points with his/her right hand to a location on his/her left arm. The ratio of, on the one hand, the length of the left arm between the user's left shoulder and the location and, on the other hand, the length of the left arm between the location and the user's left wrist can then be used to indicate the desired volume setting of a sound-reproducing system included in the gesture-controllable system of the invention.

Semaphoric gestures refer to any gesturing system that employs a stylized dictionary of static or dynamic gestures of a bodily part, e.g., the user's hand(s) or arm(s). For example, the user points with his/her left hand to the user's right elbow and taps the right elbow twice. This dynamic gesture can be used in the sense of, e.g., a double mouse-click.

Symbolic gestures, also referred to as iconic gestures, are typically used to illustrate a physical attribute of a physical, concrete item. For example, the user puts his/her hands in front of him/her with the palms facing each other. A diminishing distance between the palms is then used as a control command, for example, to change the volume of sound reproduced by the sound-reproducing system accommodated in the gesture-controllable system of the invention. The magnitude of the change per unit of time may be made proportional to the amount by which the distance decreases per unit of time. Similarly, the user may position his/her right hand so that the palm of the right hand faces downwards. Decreasing the height of the hand relative to the floor is then interpreted as decreasing the volume of sound accordingly as in above example.

The system in the invention may have been configured for being controllable through one or more pre-determined gestures, each respective one thereof being static or dynamic. The spatial relationship between the bodily part and the pre-determined reference in a static gesture does not substantially change over time. That is, the position, or the orientation, of the bodily part does not change enough over time relative to the pre-determined reference in order to render the static gesture un-interpretable by the contactless user-interface in the system of the invention. An example of a static gesture is the example of a deictic gesture, briefly discussed above. A dynamic gesture, on the other hand, is characterized by a movement of the bodily part relative to the pre-determined reference. The spatial relationship between the bodily part and the pre-determined reference is then characterized by a change in position, or in orientation, of the bodily part relative to the pre-determined reference. Examples of a dynamic gesture are the example of the semaphoric gesture and the example of the symbolic gesture, briefly discussed above.

Accordingly, the spatial relationship is representative of at least one of: a relative position of the bodily part with respect to the pre-determined reference; a relative orientation of the bodily part with respect to the pre-determined reference; and a relative movement of the bodily part, i.e., a change in position and/or orientation of the bodily part, with respect to the pre-determined reference.

The system in the invention may be implemented in a single physical entity, e.g., an apparatus with all gesture-controllable functionalities within a single housing.

Alternatively, the system in the invention is implemented as a geographically distributed system. For example, the camera system is accommodated in a mobile device with a data network interface, e.g., a Smartphone, the data processing system comprises a server on the Internet, and the gesture-controllable functionality of the system in the invention is accommodated in electronic equipment that has an Interface to the network. In this manner, the user of the mobile device is enabled to remotely control the equipment through one or more gestures. Note that a feedback loop may, but need not, be used in the process of the user's controlling the equipment in the system of the invention. The spatial relationship between a user's bodily part and the reference, i.e., a relative position and/or a relative orientation and/or relative movement, as captured by the camera system sets the desired operational state of the equipment.

In a further embodiment of a system according to the invention, at least one of the pre-determined reference, the pre-determined spatial relationship and the pre-determined state is programmable or re-programmable.

Accordingly, the system of the further embodiment can be programmed or re-programmed, e.g., by the user, by the installer of the system, by the manufacturer of the system, etc., so as to modify or build the system according to the specifications or preferences of the individual user.

The invention also relates to a contactless user-interface configured for use in a system for enabling a user to control the system in operational use through a pre-determined gesture of a bodily part of the user. The user-interface comprises a camera system and a data processing system. The camera system is configured for capturing video data, representative of the bodily part and of an environment of the bodily part. The data processing system is coupled to the camera system and is configured for processing the video data for: extracting from the video data a current spatial relationship between the bodily part, and a pre-determined reference in the environment; determining if the current spatial relationship matches a pre-determined spatial relationship between the bodily part and the pre-determined reference, the pre-determined spatial relationship being characteristic of the pre-determined gesture; and producing a control command for setting the system into a pre-determined state, in dependence on the current spatial relationship matching the pre-determined spatial relationship. The pre-determined reference comprises at least one of: another bodily part of the user; a physical object external to the user and within the environment; and a pre-determined spatial direction in the environment.

The invention can be commercially exploited in the form of a contactless user-interface of the kind specified above. Such a contactless user-interface can be installed at any system that is configured for being user-controlled in operational use. The contactless user-interface of the invention tries to match the current spatial relationship between the bodily part and a pre-determined reference in the environment, with a pre-determined spatial relationship. If the matching is successful, the current spatial relationship is mapped onto a pre-determined control command so as to set the system to a pre-determined state associated with the pre-determined spatial relationship.

In an embodiment of the contactless user-interface, the pre-determined spatial relationship is representative of at least one of: a relative position of the bodily part with respect to the pre-determined reference; a relative orientation of the bodily part with respect to the pre-determined reference; and a relative movement of the bodily part with respect to the pre-determined reference.

In a further embodiment of the contactless user-interface, at least one of the pre-determined reference, the pre-determined spatial relationship and the pre-determined state is programmable or re-programmable.

The invention can also be commercially exploited as a method. The invention therefore also relates to a method for controlling a system in response to a pre-determined gesture of a bodily part of the user. The method comprises receiving video data, representative of the bodily part and of an environment of the bodily part; and processing the video data. The processing of the video data comprises: extracting from the video data a current spatial relationship between the bodily part and a pre-determined reference in the environment; determining if the current spatial relationship matches a pre-determined spatial relationship between the bodily part and the pre-determined reference, the pre-determined spatial relationship being characteristic of the pre-determined gesture; and producing a control command for setting the system into a pre-determined state, in dependence on the current spatial relationship matching the pre-determined spatial relationship. The pre-determined reference comprises at least one of: another bodily part of the user; a physical object external to the user and within the environment; and a pre-determined spatial direction in the environment.

The video data may be provided by a camera system at runtime. Alternatively, the video data may be provided as included in an electronic file with pre-recorded video data. Accordingly, a video clip of a user making a sequence of gestures of the kind associated with the invention can be mapped onto a sequence of states to be assumed by the system in the order of the sequence.

The method may be commercially exploited as a network service on a data network such as, e.g., the Internet. A subscriber to the service has specified in advance one or more pre-determined spatial relationships and one or more pre-determined control commands for control of a system. The user has also specified which particular one of the pre-determined spatial relationships is to be mapped onto a particular one of the control commands. The service provider creates a database of the pre-determined spatial relationships and the pre-determined control commands and the correspondences there between. The user has also specified in advance a destination address on the data network. Accordingly, when the user has logged in to this service, and uploads or streams video data representative of the gestures of the user and the environment of the user, the service provider carries out the method as specified above and sends the control command to the destination address.

In a further embodiment of the method according to the invention, the pre-determined spatial relationship is representative of at least one of: a relative position of the bodily part with respect to the reference; a relative orientation of the bodily part with respect to the reference; and a relative movement of the bodily part with respect to the pre-determined reference.

In yet a further embodiment of the method according to the invention, at least one of the pre-determined reference, the pre-determined spatial relationship and the pre-determined state is programmable or re-programmable.

The invention may also be commercially exploited by a software provider. The invention therefore also relates to control software. The control software is provided as stored on a computer-readable medium, e.g., a magnetic disk, an optical disc, a solid-state memory, etc. Alternatively, the control software is provided as an electronic file that can be downloaded over a data network such as the Internet. The control software is operative to configure a system so as to be controllable in response to a pre-determined gesture of a bodily part of the user. The control software comprises first instructions for processing video data, captured by a camera system and representative of the bodily part and of an environment of the bodily part. The first instructions comprise: second instructions for extracting from the video data a current spatial relationship between the bodily part and a pre-determined reference in the environment; third instructions for determining if the current spatial relationship matches a pre-determined spatial relationship between the bodily part and the pre-determined reference, the pre-determined spatial relationship being characteristic of the pre-determined gesture; and fourth instructions for producing a control command for setting the system into a pre-determined state, in dependence on the current spatial relationship matching the pre-determined spatial relationship. The pre-determined reference comprises at least one of: another bodily part of the user; a physical object external to the user and within the environment; and a pre-determined spatial direction in the environment.

The control software may therefore be provided for being installed on a system with a contactless user-interface configured for enabling a user to control the system in operational use through a pre-determined gesture of a bodily part of the user.

In a further embodiment of the control software according to the invention, the pre-determined spatial relationship is representative of at least one of: a relative position of the bodily part with respect to the reference; a relative orientation of the bodily part with respect to the reference; and a relative movement of the bodily part with respect to the pre-determined reference.

In yet a further embodiment of the method according to the invention, the control software comprises fifth instructions for programming or re-programming at least one of: the pre-determined reference, the pre-determined spatial relationship and the pre-determined state.

### BRIEF DESCRIPTION OF THE DRAWING

The invention is explained in further detail, by way of example and with reference to the accompanying drawing, wherein:

FIG. 1 is a block diagram of a system in the invention;

FIG. 2 is a diagram of the user as captured in the video data;

FIGS. 3, 4, 5 and 6 are diagrams illustrating a first gesture-control scenario according to the invention; and

FIGS. 7 and 8 are diagrams illustrating a second gesture-control scenario according to the invention.

Throughout the Figures, similar or corresponding features are indicated by same reference numerals.

### DETAILED EMBODIMENTS

FIG. 1 is a block diagram of a system 100 according to the invention. The system 100 comprises a contactless user-interface 102 configured for enabling a user to control the system 100 in operational use through a pre-determined gesture of a bodily part of the user, e.g., the user's hands or arms. In the diagram, the system 100 is shown as having a first controllable functionality 104 and a second controllable functionality 106. The system may have only a single functionality that is controllable through a gesture, or more than two functionalities, each respective one thereof being controllable through respective gestures.

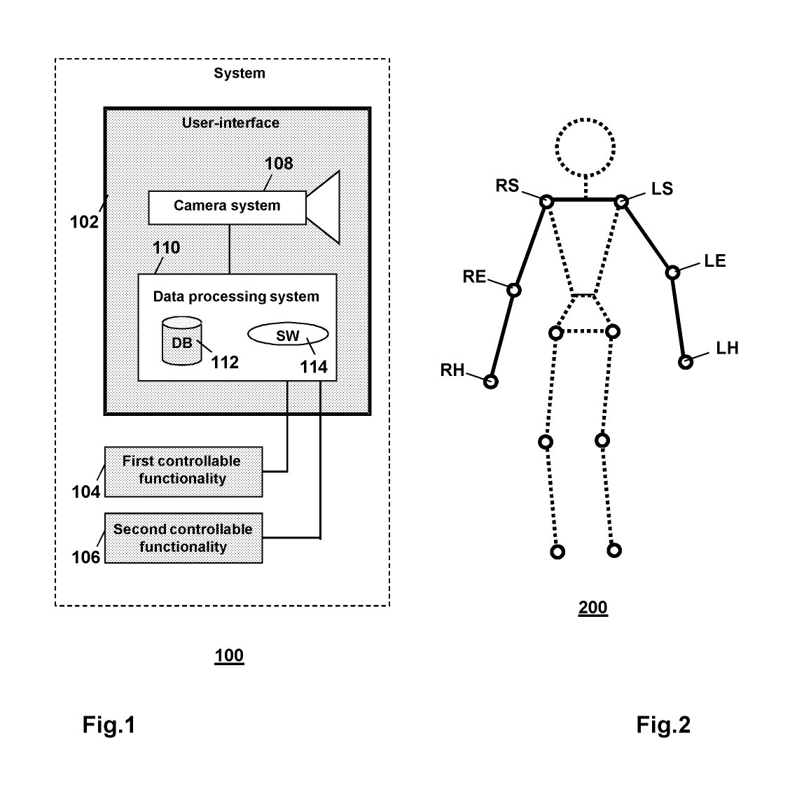

The user-interface 102 comprises a camera system 108 and a data processing system 110. The camera system 108 is configured for capturing video data, representative of the bodily part and of an environment of the bodily part. The data processing system 110 is coupled to the camera system 108 and is configured for processing the video data received from the camera system 108. The camera system 108 may supply the video data as captured, or may first pre-process the captured video data before supplying the pre-processed captured video data to the data processing system 110. The data processing system 110 is operative to determine a current or actual spatial relationship between the bodily part and a pre-determined reference in the environment. Examples of actual spatial relationships will be discussed further below and illustrated with reference to FIGS. 2-8. The data processing system 110 is operative to determine whether the current spatial relationship matches a pre-determined spatial relationship representative of the pre-determined gesture. In order to be able to do so, the data processing system 110 comprises a database 112. The database 112 stores data, representative of one or more pre-determined spatial relationships. The data processing system 110 tries to find a match between, on the one hand, input data that is representative of the current spatial relationship identified in the video data and, on the other hand, stored data in the database 112 and representative of a particular one of the pre-determined spatial relationships. A match between the current spatial relationship identified in the video data and a particular pre-determined spatial relationships stored in the database 112 may not be a perfect match. For example, consider a scenario wherein a difference between any pair of different ones of the pre-determined spatial relationships is computationally large enough, i.e., wherein the data processing system 110 can discriminate between any pair of the pre-determined spatial relationships. The data processing system 110 can then subject the current spatial relationship identified in the video data to, for example, a best-match approach. In the best-match approach, the current spatial relationship in the video data matches a particular one of the pre-determined relationships, if a magnitude of the difference between the current spatial relationship and the particular pre-determined spatial relationship complies with one or more requirements. A first requirement is that the magnitude of the difference is smaller than each of the magnitudes of respective other differences between, on the one hand, the current spatial relationship and, on the other hand, a respective other one of the pre-determined spatial relationships. For example, the current spatial relationship is mapped onto a vector in an N-dimensional space, and each specific one of the pre-determined spatial relationships is mapped onto a specific other vector in the N-dimensional space. As known, a difference between a pair of vectors in an N-dimensional space can be determined according to a variety of algorithms, e.g., determining a Hamming distance.

The term “database” as used in this text may also be interpreted as covering, e.g., an artificial neural network, or a Hidden Markov Model (HMM) in order to determine whether the current spatial relationship matches a pre-determined spatial relationship representative of the pre-determined gesture.

A second requirement may be used that specifies that the magnitude of the difference between the current spatial relationship and the particular pre-determined spatial relationship is below a pre-set threshold. This second requirement may be used if the vectors representative of the pre-determined spatial relationships are not evenly spaced in the N-dimensional space. For example, consider a set of only two pre-determined spatial relationships, and consider representing each respective one of these two pre-determined spatial relationships by a respective vector in a three-dimensional space, e.g., an Euclidean three-dimensional space spanned by the unit vectors along an x-axis, a y-axis and a z-axis that are orthogonal to one another. It may turn out that the two vectors, which represent the two pre-determined spatial relationships, both lie in the half-space characterized by a positive z-coordinate. Now, the current spatial relationship of the video data is represented by a third vector in this three-dimensional space. Consider the case wherein this third vector lies in the other half-space characterized by a negative z-coordinate. Typically, the difference between this third vector and a particular one of the two vectors of the two pre-determined spatial relationships is smaller than another difference between this third vector and the other one of the two vectors of the two pre-determined spatial relationships. Formally, there would be a match between this third vector and the particular one of the two vectors. However, it may well be that the user's movements are not meant at all as a gesture for controlling the system 100. Therefore, the second requirement (having the magnitude of the difference between the current spatial relationship and the particular pre-determined spatial relationship below a pre-set threshold) can be used to more reliably interpret the movements of the user as an intentional gesture to control the system 100.

The data processing system 110 may be a conventional data processing system that has been configured for implementing the invention through installing suitable control software 114, as discussed earlier.

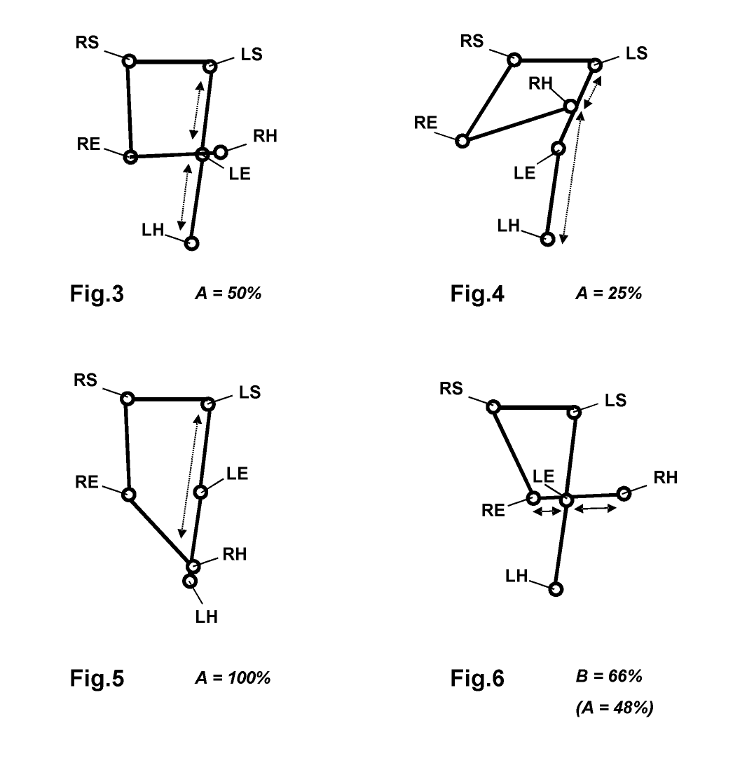

FIG. 2 is a diagram of the user as captured in the video data produced by the camera system 108. The camera system 108 produces video data with a matchstick representation 200 of the user. Implementing technology has been created by, e.g., Primesense, Ltd., an Israelian company, and is used in the 3D sensing technology of the “Kinect”, the motion-sensing input device from Microsoft for control of the Xbox 360 video game console through gestures, as mentioned above. The matchstick representation 200 of the user typically comprises representations of the user's main joints. The matchstick representation 200 comprises a first representation RS of the user's right shoulder, a second representation LS of the user's left shoulder, a third representation RE of the user's right elbow, a fourth representation LE of the user's left elbow, a fifth representation RH of the user's right hand, and a sixth interpretation LH of the user's left hand. The relative positions and/or orientations of the user's hands, upper arms, and forearms can now be used for control of the system 100 in the invention, as illustrated in FIGS. 3, 4, 5, 6, 7 and 8. Below, references to the components of the user's anatomy (shoulder, forearm, upper arm, hand, wrist, and elbow) and the representations of the components in the matchstick diagram will be used interchangeably.

For clarity, in human anatomy, the term “arm” refers to the segment between the shoulder and the elbow, and the term “forearm” refers to the segment between the elbow and the wrist. In casual usage, the term “arm” often refers to the entire segment between the shoulder and the wrist. Throughout this text, the expression “upper arm” is used to refer to refer to the segment between the shoulder and the elbow.

FIGS. 3, 4, 5 and 6 illustrate a first control scenario, wherein a position of an overlap of the user's right arm with the user's left arm is representative of the magnitude of a first controllable parameter, e.g., the volume of a sound reproduced by a loudspeaker system represented by the first functionality 104 of the system 100. The position of the overlap is interpreted relative to the user's left arm.

In the first control scenario, the user's left arm is used as if it were a guide, wherein a slider can be moved up or down, the slider being represented by the area wherein the user's left arm and the user's right arm overlap or touch each other in the video data. A slider is a conventional control device in the user-interface of, e.g., equipment for playing out music, and is configured for manually setting a control parameter to the desired magnitude. In the first control scenario of the invention, the volume of the sound can be set to any magnitude between 0% and 100%, depending on where the user's right arm is positioned relative to the user's left arm.

In the diagram of FIG. 3, the user's right forearm, represented in the diagrams as a stick between the right elbow RE and the right hand RH, is positioned at, or close to, the representation of the user's left elbow LE. The data processing system 110 has been configured to interpret this relative position of the user's right forearm in the diagram of FIG. 3 as a gesture for adjusting the volume to about 50%. The user's sense of proprioception enables to quickly position the user's right forearm at, or close to the user's left elbow LE, and to make the user aware of small changes in this relative position. The user's right arm may rest on the user's left arm to help even more by adding the sense of touch.

In the diagram of FIG. 4, the user has positioned his/her right forearm relative to the user's left arm so that the user's right hand RH rests on the user's left arm halfway between the left elbow LE and the left shoulder LS. The data processing system 110 has been configured to interpret the relative position of the user's right forearm in the diagram of FIG. 4 as a gesture for adjusting the volume to about 25%.

In the diagram of FIG. 5, the user has positioned his/her right forearm relative to the user's left arm so that the user's right hand RH rests on the user's left arm at, or close to, the user's left hand LH. The data processing system 110 has been configured to interpret the relative position of the user's right forearm in the diagram of FIG. 5 as a gesture for adjusting the volume to about 100%.

From the diagrams of FIGS. 3, 4 and 5 it is clear that the user need not keep his/her left arm completely straight. It is the relative positions of forearms and the upper arms what is relevant to the gestures as interpreted by the data processing system 110.

The diagram of FIG. 6 illustrates the first scenario, now using as a gesture the relative length, by which the user's right forearm extends beyond the user's left arm in order to set the magnitude of a second controllable parameter, e.g., a horizontal direction of a beam of light from a controllable lighting fixture, represented by the second functionality 106 of the system 100. Assume that the lighting fixture can project a beam in a direction in the horizontal plane, and that the direction can be controlled to assume a magnitude between −60° relative to a reference direction and +60° relative to the reference direction. Setting the direction roughly to the reference direction is accomplished by, e.g., positioning the user's right forearm so that the right forearm and the user's left arm overlap roughly at a region on the right forearm halfway between the right elbow RE and the right hand RH. Then, the length, by which right forearm extends to the left beyond the left arm, roughly equals the length, by which right forearm extends to the right beyond the left arm. Redirecting the beam to another angle relative to the reference direction is accomplished by the user shifting his/her right forearm relative to his/her left arm so as to change the length by which the right forearm extends beyond the left arm to, e.g., the right.

The diagram of FIG. 6 also illustrates the first scenario, wherein the first controllable parameter and the second controllable parameter are simultaneously gesture-controllable. Consider, for example, a case wherein the first controllable parameter represents the volume of sound produced by a loudspeaker system, as discussed above with reference to the diagrams of FIGS. 3, 4 and 5, and wherein the second controllable parameter represents the directionality of the sound in the loudspeaker system. The volume is controlled by the position of the overlap between the right forearm and the left arm, relative to the left arm, and the directionality is controlled by the ratio of the lengths, by which the right forearm extends to the left and to the right beyond the left arm. In the example illustrated in the diagram of FIG. 6, the volume has been set to about 48% and the directionality to about 66%. As to the latter magnitude: the distance between the user's left arm and the user's right hand RH is shown as about twice as long as the distance between the user's left arm and the user's right elbow RE.

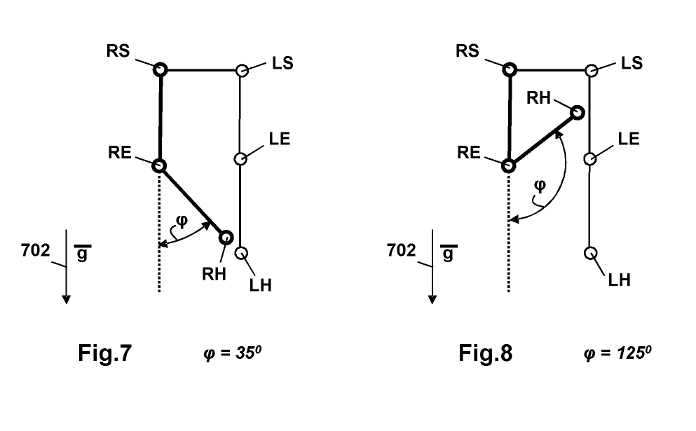

The diagrams of FIGS. 7 and 8 illustrate a second scenario, wherein the data processing system 110 interprets as a gesture the position of the user's right forearm relative to a reference direction, here the direction of gravity, indicated by an arrow 702. The relative position of the right forearm is represented by an angle φ between the direction of gravity 702 and a direction of the segment between the right elbow RE and the right hand RH in the matchstick diagram. In the diagram of FIG. 7, the relative position of the right forearm is such that the angle φ assumes a magnitude of, say, 35°. In the diagram of FIG. 8, the relative position of the right forearm is such that the angle φ assumes a magnitude of, say, 125°. Accordingly, the magnitude of the angle φ can be used by the data processing system 110 to set the value of a controllable parameter of the system 100.

In the examples above, the data processing system 110 uses as input the relative position of the overlap of the right forearm with the left arm, and/or the ratio of the lengths by which the right forearm extends beyond the left arm to the left and to the right, and the position of the right forearm relative to the direction of gravity as represented by the angle φ. The data processing system 110 may be configured to use any kind of mapping of the input to an output for control of one or more controllable parameters. The mapping need not be proportional, and may take, e.g., ergonomic factors into consideration. For example, it may be easier for the user to accurately position his/her right hand RH at a location close to his/her left elbow LE than at a location halfway his/her left elbow LE and his/her left shoulder LS. A mapping of the relative position of the overlap of the right forearm and the left arm may then be implemented wherein a certain amount of change in relative position of the overlap brings about a larger change in the magnitude of the value of the controllable parameter if the overlap occurs near the left elbow LE than in case the overlap occurs halfway his/her left elbow LE and his/her left shoulder LS.

In the examples illustrated in FIGS. 3, 4, 5, 6, 7 and 8, the data processing system 110 is configured for mapping a specific relative position on a specific magnitude of a controllable parameter.

Alternatively, the data processing system 110 is configured for mapping a specific relative position onto a selection of a specific item in a set of selectable items. Examples of a set of selectable items include: a playlist of pieces of pre-recorded music or a playlist of pre-recorded movies; a set of control options in a menu of control options available for controlling the state of electronic equipment, etc. For example, assume that the first controllable functionality 104 of the system 100 comprises a video playback functionality. The video playback functionality is gesture-controllable, using the left forearm as reference. Touching the left forearm with the right hand RH close to the left elbow LE is then interpreted as: start the video playback at the beginning of the electronic file of the selected movie. Touching the left forearm halfway between the left elbow LE and the left hand LH is then interpreted as: start or continue the video playback in the halfway of the movie. Touching the left forearm close to the left hand LH is then interpreted as: start or continue the video playback close to the end of the movie.

In FIGS. 3, 4, 5 and 6, the position of the user's right arm is described relative to the pre-determined reference being the user's left arm. In FIGS. 7 and 8, the position of the user's right arm is described relative to the pre-determined reference being the direction of gravity 702. Note that the invention in general has been described in terms of a specific gesture being formed by a specific spatial relationship between a bodily part of the user, e.g., the user's right arm, the user's left arm, the user's head, the user's left leg, the user's right leg, etc., and a pre-determined reference. The pre-determined reference may include another bodily part of the user, e.g., the other arm, the other leg, the user's torso, etc., another pre-determined direction than that of gravity, or a physical object, or part thereof, in the environment of the user as captured by the camera system. The specific spatial relationship may be represented by relative position, and/or relative orientation and/or relative movement of the bodily part and the pre-determined reference.

1-3. (canceled)

4. A contactless user-interface configured for use in a system for enabling a user to control the system in operational use through a pre-determined gesture of a bodily part of the user, wherein:
the user-interface comprises a camera system and a data processing system;
the camera system is configured for capturing video data, representative of the bodily part and of an environment of the bodily part;
the data processing system is coupled to the camera system and is configured for processing the video data for:
extracting from the video data a current spatial relationship between the bodily part, and a pre-determined reference in the environment;
determining if the current spatial relationship matches a pre-determined spatial relationship between the bodily part and the pre-determined reference, the pre-determined spatial relationship being characteristic of the pre-determined gesture; and
producing a control command for setting the system into a pre-determined state, in dependence on the current spatial relationship matching the pre-determined spatial relationship; and
the pre-determined reference comprises a physical object external to the user and within the environment.

5. The contactless user-interface of claim 4, wherein the pre-determined spatial relationship is representative of at least one of:
a relative position of the bodily part with respect to the pre-determined reference;
a relative orientation of the bodily part with respect to the pre-determined reference; and
a relative movement of the bodily part with respect to the pre-determined reference.

6. The contactless user-interface of claim 4, wherein at least one of the pre-determined reference, the pre-determined spatial relationship and the pre-determined state is programmable or re-programmable.

7. A method for controlling a system in response to a pre-determined gesture of a bodily part of the user, wherein the method comprises:
receiving video data, captured by a camera system and representative of the bodily part and of an environment of the bodily part; and
processing the video data;
the processing of the video data comprises:
extracting from the video data a current spatial relationship between the bodily part and a pre-determined reference in the environment;
determining if the current spatial relationship matches a pre-determined spatial relationship between the bodily part and the pre-determined reference, the pre-determined spatial relationship being characteristic of the pre-determined gesture; and
producing a control command for setting the system into a pre-determined state, in dependence on the current spatial relationship matching the pre-determined spatial relationship;
and the pre-determined reference comprises a physical object external to the user and within the environment.

8. The method of claim 5, wherein the pre-determined spatial relationship is representative of at least one of:
a relative position of the bodily part with respect to the reference;
a relative orientation of the bodily part with respect to the reference; and
a relative movement of the bodily part with respect to the pre-determined reference.

9. The method of claim 7, wherein at least one of the pre-determined reference, the pre-determined spatial relationship and the pre-determined state is programmable or re-programmable.

10. Control software stored on a computer-readable medium and operative to configure a system so as to be controllable in response to a pre-determined gesture of a bodily part of the user, wherein:
the control software comprises first instructions for processing video data, captured by a camera system and representative of the bodily part and of an environment of the bodily part;
the first instructions comprise:
second instructions for extracting from the video data a current spatial relationship between the bodily part and a pre-determined reference in the environment;
third instructions for determining if the current spatial relationship matches a pre-determined spatial relationship between the bodily part and the pre-determined reference, the pre-determined spatial relationship being characteristic of the pre-determined gesture; and
fourth instructions for producing a control command for setting the system into a pre-determined state, in dependence on the current spatial relationship matching the pre-determined spatial relationship; and
the pre-determined reference comprises a physical object external to the user and within the environment.

11. The control software of claim 10, wherein the pre-determined spatial relationship is representative of at least one of:
a relative position of the bodily part with respect to the reference;
a relative orientation of the bodily part with respect to the reference; and
a relative movement of the bodily part with respect to the pre-determined reference.

12. The control software of claim 10, comprising fifth instructions for programming or re-programming at least one of: the pre-determined reference, the pre-determined spatial relationship and the pre-determined state.

13. A system for enabling a user to control the system in operational use through a pre-determined gesture of a bodily part of the user, comprising the contactless user-interface as claimed in any of the preceding claims.
